(19) United States
(12) Patent Application Publication
(10) Pub. No.: US 2017/0289252 A1
(43) Pub. Date: Oct. 5, 2017

(54) Wall Clock with Clock Face as a Display for Displaying Information from a Plurality of Devices in the Internet of Things

(71) Applicants: Anton Zriashchev, San Carlos, CA (US); Aleksandr Potudinskii, Samara (RU); Danil Vinogradov, Samara (RU)

(72) Inventors: Anton Zriashchev, San Carlos, CA (US); Aleksandr Potudinskii, Samara (RU); Danil Vinogradov, Samara (RU)

(21) Appl. No.: 15/084,468

(22) Filed: Mar. 29, 2016

(51) Int. Cl. H04L 29/08; G04G 17/04; G04G 9/00

(52) U.S. Cl. CPC H04L 67/12; G04G 9/00; G04G 17/04

(57) ABSTRACT

Proposed is a device associated with the Internet of Things (IoT) in the form of a wall clock having a clock face as a full-color LED display with a translucent cover. The clock enclosure contains a clock mechanism and a built-in speaker. The wall clock is connected to a Cloud server for displaying data from the Internet of Things devices, such as a time preset for specific events presented on the clock face. The display has a round shape with a special at-a-glance interface that allows reading of the information shown on a display at a glance and without interruptions from a current task. The Cloud algorithms analyze data scheduled to be delivered to the receiver and decide what information is to be displayed and when the information is to be displayed.

### FIELD OF THE INVENTION

The invention relates to the Internet of Things network (hereinafter referred to as IoT) which provides interconnection with a plurality of devices such as computers, measurement instruments, health monitoring devices, various networks, and any other remotely located objects that can communicate with each other through the Internet and/or wirelessly without the Internet. More specifically, the invention relates to a wall clock with a clock face that constitutes a display for displaying information from a plurality of devices in the IoT and in connection with a preset event and/or a prescheduled time.

### BACKGROUND OF THE INVENTION

The Internet of Things (IoT) is a network in which various things or objects such as animals and people or inanimate objects such as measurement instruments, computers, smart phones, etc., are provided with specific identifiers that can transfer data in a wired or wireless manner over a network, e.g., the Internet and without human participation.

The IoT is not new. It has been discussed for decades and finds practical use in everyday life. For example, it is known in domestic applications to save energy by providing smart meters that remotely turn heating systems on or off, lower room temperature on a sunny day, or increase room temperature when it drops below a certain limit. Such control is done automatically without human participation.

Manufacturing is probably the furthest advanced in terms of the IoT, as it can be used for organizing tools, machines and people, and tracking their locations.

Another field of IoT application is medicine where smart sensors monitor the vital signs of a patient and report them in real time to a doctor.

The examples are endless, with delivery of acoustic or visual signals to a signal-receiving site, e.g., to a display.

For example, US Published Patent Application 20140337956 A1 published in 2014 (Inventor, P. Korgaonkar) discloses a system and method for multifactor authentication and login through a smart wrist watch using a near-field communication technology tag with a computing device such as a mobile phone, tablet, laptop, desktop, or any similar system.

U.S. Pat. No. 9,210,192 issued on Dec. 8, 2015 to Kim, et al., discloses the setup of multiple devices on a local area network. Specifically, various techniques and systems are provided for using a network device to efficiently add a new device to a local area network using an existing network device. Exemplary embodiments of the invention include a computer-implemented method. The access device may include any human-to-machine interface with a network connection capability that allows access to a network. For example, the access device can include a stand-alone interface (e.g., cellular telephone, smartphone, home computer, laptop computer, tablet, personal digital, assistant (PDA), computing device, wearable device such as a smart watch, wall panel, Internet-enabled device such as a wall switch, control interface, or other suitable interfaces), or the like.

Another example of an IoT application as a hardware-software platform that works with data from IoT devices and web-services is a conventional smartphone, where the screen of the phone is used for displaying information obtained from various devices, networks, or communication systems.

However, conventional displays for displaying information obtained through an IoT is intended only for individual use or requires a switching operation for observation. Such displays are not always associated with observation of the current time. They have a small or limited surface for display of the information at a glance without watching the details or reading tiny letters.

### SUMMARY OF THE INVENTION

A device of the invention associated with an IoT may be exemplified by a wall clock with two mechanical hands (minutes and hours) having a clock face in the form of a full-color LED display with a semitransparent cover. The clock enclosure contains a clock mechanism and a built-in speaker. The wall clock is connected to a Cloud server for displaying data from the Internet of Things network such as a time preset for specific events presented. The display has a round shape with a special interface that allows reading of the information shown at a glance and without interruptions from a current task. The Cloud algorithms analyze the data scheduled to be delivered to the receiver and decide what information is to be displayed and when the information is to be displayed.

### BRIEF DESCRIPTION OF THE DRAWINGS

FIG. 1 is an exploded view of the wall clock of the present invention.

FIG. 2 is a sectional view of a color-mixing chamber used in the wall clock of the invention.

FIG. 3 is a block scheme of electric and electronic devices that are placed on a printed circuit board in the wall clock of the present invention.

FIG. 4 shows an example of color codes that may be shown on the display used in the wall clock of the present invention.

FIG. 5 shows the overall system structure that includes the wall clock of the invention and the associated IoT.

FIG. 6 shows a more detailed system structure that includes the wall clock of the invention.

FIG. 7 is a front view of the wall clock of the invention with light indicators for group use of the wall clock of the invention.

### DETAILED DESCRIPTION OF THE INVENTION

The invention relates to the field of the Internet of Things (IoT) network which provides interconnection with a plurality of devices such as computers, measurement instruments, health monitoring devices, various networks, and any other remotely located objects that can wirelessly communicate with each other. More specifically, the invention relates to a wall clock with a clock face that constitutes a display for displaying information from a plurality of devices in the IoT and in connection with a preset event and/or a prescheduled time. Another distinguishing feature of the wall clock of the invention is that it allows receipt of information instantly and at a glance without watching details or reading tiny characters. This is achieved by using color-coded information reproduced on a full-color display with an optically translucent cover that functions as a front panel and a clock face of the wall clock of the invention. The color-coded images obtained from IoT devices are reproduced on the front panel by means of a plurality of full-color RGB LEDs. Textual information is displayed by a plurality of monochromatic (basically white) LEDs.

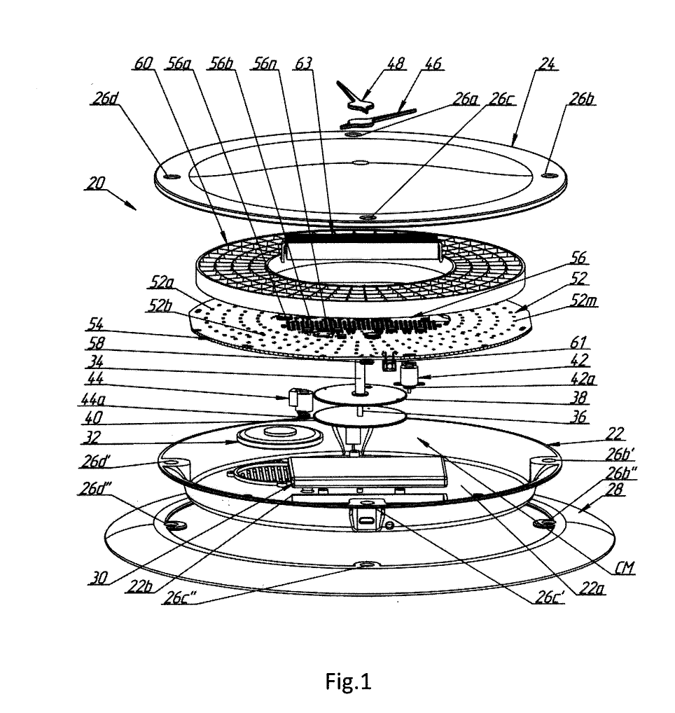

A mechanical scheme of the wall clock of the invention is shown in FIG. 1, which is an exploded view of the clock.

More specifically, the main external parts of the wall clock of the invention (hereinafter referred to as “clock”), which in an assembled state is designated by reference numeral 20, are a plate-shaped back cover or enclosure 22 that contains main internal components and mechanisms of the clock 20, and a translucent front panel 24 that is attached to the upper edge of the enclosure 22 for covering its interior and that, as mentioned above, also functions as a display and a clock face. The clock face, which is made in the form of a translucent cover, is also used for designating hours and minutes and for reproducing images as projections of light emitted by LEDs. In the illustrated modification, the enclosure 22 is provided with a ring-shaped, interchangeable frame 28 that can be used for decorative purposes or can be attached to a wall or other vertical or non-vertical mounting.

The translucent front panel 24 can be attached to the enclosure, e.g., by screws (not shown) inserted through the openings 26a, 26b, 26c, 26d via through-holes 26b′, 26c′, 26d′ (the respective fourth hole is not seen in FIG. 1) of the enclosure 22 into threaded holes 26b″, 26c″, and 26d″ (the respective fourth threaded hole is not seen in FIG. 1) of the frame 28. The threaded holes 26b′, 26c′, 26d′, etc., can be formed in lugs on the inner wall of the enclosure 22.

The interchangeable frame 28 can be molded from plastic, such as polymethyl methacrylate (PMA), polymethylmethacrylate (PMMA), acrylonitrile butadiene styrene (ABS), etc, or from wood, metal, or another material, and may have any shape and finishing other than that shown in FIG. 1. The enclosure 22 can be molded from plastic or made from aluminum or another metal. The translucent front panel 24 can be made from plastic, Glassor™ fabric and can be white, black or any other color and may have a matte, glossy, or other finish.

The basic version may have two-way power using a cable and a rechargeable battery or standard-size battery. Attachable to the bottom 22a of the enclosure 22 is a compartment for an electric battery 30, which is accessible for replacement through a window 22b provided at the bottom 22a of the enclosure 22.

The battery 30 may be a rechargeable service-free Li-Ion battery or a standard-size battery of NiMH or LD NiMH type that can be obtained from Thomas Battery Supply & Electronics, IL. Batteries may have different chemistry, size, and electrical properties. There can be modifications without a rechargeable battery and with standard batteries such as AA.

Reference numeral 32 designates a speaker that is located in the interior of the enclosure 22 and may have different sizes, shapes, and electromechanical properties. As an example, this may be a round-shaped 80 HM, 3 W, 20 mm speaker produced by CUI, Inc. (OR) and distributed by Digi-Key© Electronics, MN. Reference numeral 32a designates sound-passing openings formed in the bottom 22a of the enclosure 22 for transmitting sounds reproduced by the speaker.

The clock mechanism CM, per se, consists of an outer hollow shaft 34 rotationally installed in the enclosure 22, an internal shaft 36 rotationally installed in the hollow shaft 34 coaxially therewith, a gearwheel 38 fixed on the outer shaft 34, a minute-hand stepper motor 42 having on its output shaft a pinion 42a engaged with the gear wheel 38, and an hour-hand stepper motor 44 having on its output shaft a pinion 44a engaged with a gearwheel 40. The aforementioned shaft extends beyond the outer surface of the translucent front panel 24. The minute-hand 46 of the clock is attached to the protruding end of the shaft 38, and the hour-hand 48 of the clock is attached to the protruding end of the shaft 34.

The stepper motors 42 and 44 may be obtained in different types and dimensions, e.g., from Vitech Technology Co., Ltd. (China). The motor of this type may have, e.g., the following characteristics: diameter of 10 mm, step angle of 18 degrees, 2 phases, bipolar drive system, 5 V, winding resistance of 15 Ohm, and weight of 12.6 g.

Located above the clock mechanism CM is a custom PCB board 54 with a circular array 50 of RGB LEDs 52a, 52b, 52m composed of “m”-number RGB LEDs arranged in the form of a plurality of concentric circles. The m-number of these full-color PCB LEDS and their arrangement depends on a particular modification of the clock 20.

A linear array of “n”-number LEDs 56a, 56b, . . . 56n, preferably monochromatic white LEDs, is intended for displaying textual information. The n-number and the dimensions of the linear array depend on a specific model of the clock 20.

The clock is provided with a micro USB connector 58 for charging and with a tactile button 61 for switching the clock ON and OFF, as well as for setting various operational functions such “pair”, “reset”, etc. The micro USB connector and the tactile button are exposed to the outer surface of the enclosure 22 for easy access.

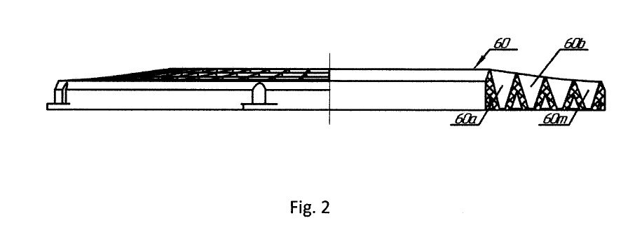

FIG. 2 is a sectional view of a color-mixing chamber 60 that has a convex shape and comprises a matrix of “m” circularly arranged cells 60a, 60b, . . . 60m expanded toward the cover so that the cells are aligned with respective “m” RGB LEDs. These cells form clear and sharp pixels at the front panel of the clock 20. More specifically, the cells produce multiple mixing of light beams emitted by the RGB LEDs and reflected from the cell walls. Each LED is placed into a separate cell. Each cell may have a unique shape that increases light output, mixes colors from RGB LED crystals, and avoids light interpenetration from nearby LEDs.

In the example illustrated in FIG. 2, the RGB LEDs 52a, 52b, . . . 52m are preassembled as a single LED matrix with a custom printed circuit board that also contains components of electrical control and wiring. The single LED matrix has a convex cross-sectional shape that corresponds to the shape of the color-mixing chamber 60 so that when the color-mixing chamber 60 is placed over the RGB matrix of LEDs, the LEDs protrude into the respective cells 60a, 60b, . . . 60m, which expand toward the cover.

In their shape, the cells expand toward the translucent cover. According to one aspect of the invention, the cells may be tapered. The convergence angle of each cell is selected so as to provide the most uniform distribution of light emitted from the matrix. For the structure shown in the drawings, in which the cells are tapered, the divergence angle varies in the range of 30 to 70 degrees. These numbers are given only as an example. Thus, the custom PCB board 54 shown in FIG. 1 contains components of the electrical control, wiring, and light sources.

If necessary, the matrix can be assembled from individual LEDs secured in the respective cells and electrically connected to a PCB board.

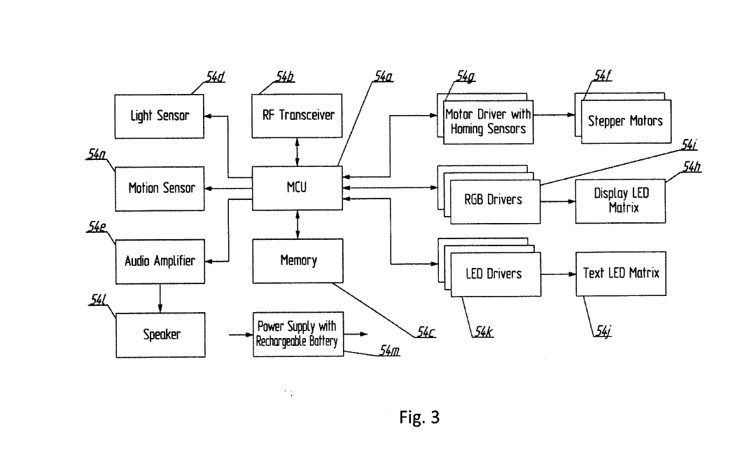

A block scheme of electric and electronic devices of the clock 20, which are placed on a printed circuit board, is shown in FIG. 3. The MCU 54a, which is the “brain” of the clock, communicates with the RF transceiver 54b that receives signals from IoT devices through the Cloud (not shown in FIG. 3). The MCU is connected via one-way or two-way links with the memory unit 54c, light sensor 54d, auto amplifier 54e, stepper motors 54f via the respective drivers 54g with sensors, the display LED matrix 54h via the RGB drivers, and the text LED matrix 54j via the LED drivers. In addition, the auto amplifier is connected with the speaker 541. LED drivers 54k control Text LED matrix 54j. A power supply with battery 54m powers the appropriate components of the clock.

The clock of the invention has a special interface that displays data in geometric shapes rather than as text or numbers. Scientists proved that the human brain recognizes changes in shape, color, direction, and size much quicker than reading text or calculating numbers. The interface of the clock of the invention that has a clock face employed as a display was developed based on the above principle. More specifically, signal information that can be instantly perceived at a glance is reproduced on the translucent front panel 24 (FIG. 1) in a color-coded form as arcs, segments, rounded lines, or geometrical figures of other forms.

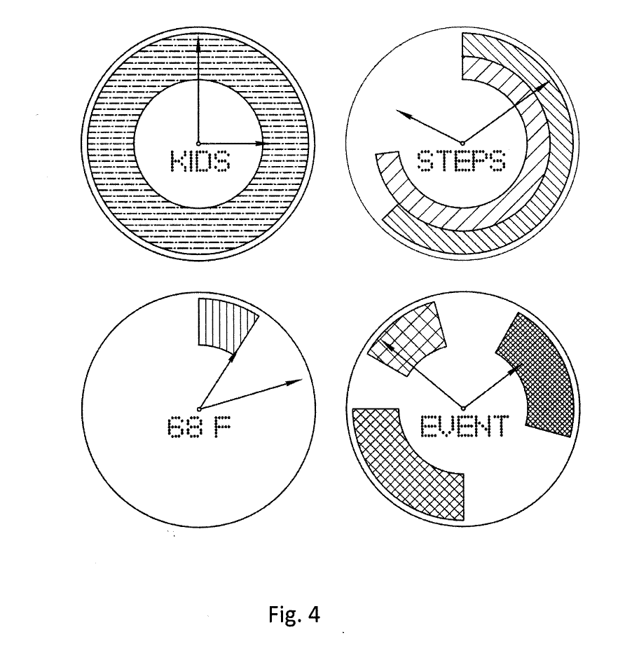

Since in the present specification the drawings are presented in a black-and-white form, FIG. 4 shows examples of color-coded data as hatched areas of FIG. 4, where the hatched areas with the highest density of cells correspond, e.g., to yellow, the areas hatched with a medium density of cells correspond to red, and the areas hatched with the lowest density of cells correspond to green.

When at least a part of each circle of LEDs is lit, the lit part of the array designates a time interval on the clock face that corresponds to a time during which a predetermined device operates in the Internet of Things.

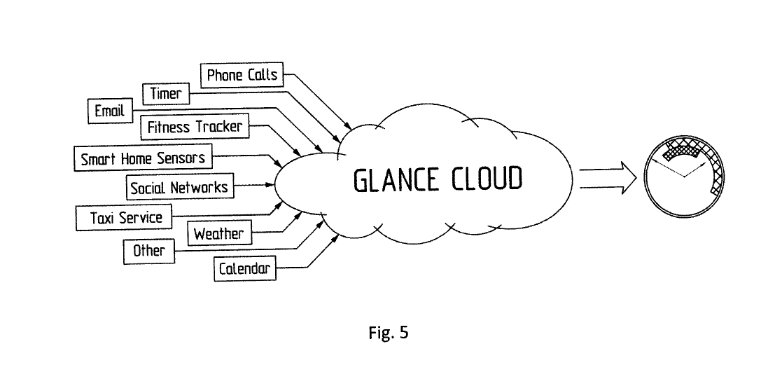

FIG. 5 shows overall system structure. Shown on the left side of the system is the number of third-party integrations that integrate to the Cloud. In general, the system obtains information from the sources/things of the IoT shown below.
Wearable devices, such as fitness trackers, heart rate monitors, blood pressure monitors and other smart wearable electronics;
Smart home sensors like indoor/outdoor temperature, air pressure, humidity, security, fire alarms, open door, door locks, etc.;
Smartphone notifications like incoming calls, text messages, reminders, alarm clock, battery level, timer events, geo position, etc.;
Web-services like a digital calendar from Google, weather forecasts, taxi services, emails, and a plurality of other existing and upcoming services.
Social network events like the number of followers, number of Likes, number of comments to recent posts, etc.

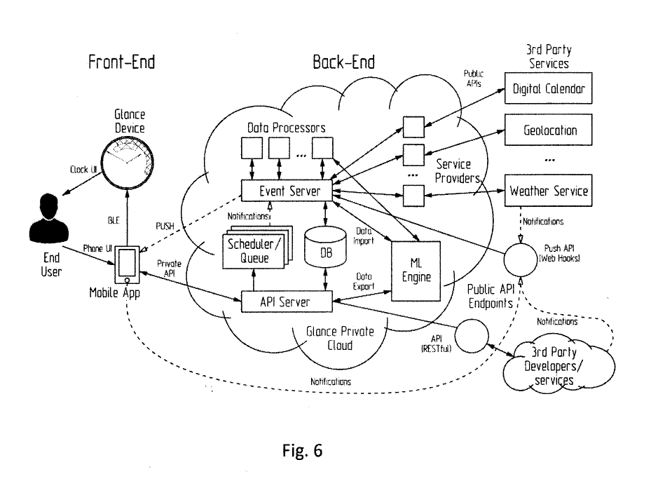

A more detailed structure of the Cloud is shown in FIG. 6. The cloud contains Internet-controlled components. The “Glance Cloud Server” is the main part of the system that has integrations with third-party IoT services and receives data, which triggers the clock. User-centric algorithms analyze data to decide what information should be displayed at a particular user's clock at a particular moment. The human-centered design can be defined as the process that places human needs and limitations in a higher priority compared with other targets during the design and production differential stages.

Cloud architecture has a modular structure and can easily increase the number of available integrations. In FIG. 6, the links between the components of the system are shown by arrows, where one arrowhead line shows one-way connection and two arrowhead lines show two-way connection.

Cloud architecture consists of several parts, which are the following:

API server: This server is used for user authorization and authentication, session management, triggers creation, change, and other functions. This is a private interface that is used internally, but some of its components will be used for third-party developers. Examples of third-party services are a digital calendar service, a geolocation service, a weather service, etc.
Event server: This component processes single triggers and chains of triggers and can react on notifications as well from Scheduler/Queue, from outer objects like mobile applications, third-party services, etc., using web hooks. The Event Server communicates with service providers to access data from third-party services. It also communicates with data processors to convert raw-source data to internal format according to algorithms.
Scheduler/Queue: This block creates a schedule and a queue of triggers to run on the Event Server. This means that the triggers are running according to the created schedule.
Service Providers: These components provide integration with third-party services using their interfaces. They also convert third-party data to internal format that is understandable to any block of the system.
Data Processors: These processors analyze all data and convert raw-source data to formats that are required by triggers. Each trigger uses the specific data that depends on integration and events.
DB: This is the main data storage, or database. All available data are stored. There are many temporary databases for caching and exchanging data (not shown).
ML Engine: This is a machine-learning engine that uses data from the Event Server and stores it to analyze. The ML Engine provides analytics that are based on stored data.
Mobile App: The Mobile Application talks to the Cloud and the clock. It is used to set up user settings and preferences and to manage data and trigger streams that are transmitted to the clock. It works on iOS, Android, or the W10 operation system.
Glance Devices: Glance Clock or another specific device that works with the Cloud.
End User: A consumer or user that uses the Glance Clock of the invention.
Web Hooks and APIs: These are public interfaces for third-party developers. This is part of the development program for independent developers that provides, access to the Glance Clock.
Third-Party Services: These are services with which the Glance Clock Cloud is integrated. More details are shown in FIG. 5. Third-party developer services are mobile applications, web applications, or other kinds of applications that are developed by independent developers for cooperation with the Glance Clock.

According to FIG. 6, all data sources are third-party services that send data to the Cloud. On the Back-End, these data are processed by Service Providers and analyzed by the Event Server, Data Processors, and the ML engine. Processed data go to the database DB. Based on API server requests, the scheduler sets a queue of triggers that trigger the Event Server to take necessary data from the database and send the push-notification to a smartphone. Then the smartphone receives data from the database trough API Server using Private APIs.

Processed and analyzed data travels from the smartphone to the user's clock. The particular moment at which data are displayed on the clock is set by the end user via the Mobile App.

The Cloud makes the final decision about what information is to be displayed and when and where it should be displayed according to a script or scenario set up by the user. It also decides a number of external parameters such as weather conditions, current time, etc. The User has an account on the Cloud and sets up the services to be shown on the clock via the Mobile App., e.g., a smart phone.

One user can have many clocks at different locations, and many users can connect to one clock. The software recognizes the person and location and displays the information that is personally relevant and also the person's location. If there is more than one person in a room with a clock, the software switches the clock to a shared mode to avoid displaying private data and, instead, displays common data related to a place rather than to a person.

The clock can display the following types of data:
1. Notifications or Binary data—Glance Clock winks and makes sound to notify user about an event. It can display any event that can be described by YES/NO, ON/OFF, or 0/1 state.
2. Countable Data—these are parameters, which are matters in numbers and basically have a goal to achieve, e.g., the number of daily steps, sleep hours during night, calories consumed/burned in a day, etc. Glance shows circular bars in different colors to display results. Different bars have different colors to make the visual data representation for data sharper and clear.
3. Relative Data—these are data which we don't understand exactly but which can be used as qualitative information, such averages and percentiles rather than absolute data. In this case, the size of the displayed segment will depend on the value of the displayed data.

The system elements described above can represent any data as well as their combinations.

### Application Examples

1. Displaying Information from Wearable Electronic Devices

In this example, user data from some sort of wristband or wearable tracking device like Jawbone or FitBit® goes to its own Cloud Server like usual. The Glance Clock Cloud server has integration with the server of the wearable device via an open API. Data from the server of the wearable device goes to the Glance Cloud Server where the data are analyzed and processed to make it ready to display at a clock. The data goes from the Cloud Server to the clock via a smart phone or a special bridge with wireless connectivity between the clock and the Cloud. The moment at which data should be displayed on the clock is determined by several options:
a. Custom time schedule, e.g., every hour or once a week.
b. Followed by triggers from third-party services. At the moment a person wakes up, a wearable device sends a trigger that awakes the person. The Glance Cloud gets the trigger and data about sleep duration and sends the data to the clock. In this case, information about sleep time and quality appears on the clock face exactly when the person wakes up.
c. Another example may relate to showing activity data right after a person has finished a workout. Here the Cloud gets a trigger that the person just finished a workout and also gets the parameters of the workout. The Cloud Server sends the information to the clock at the moment the person finished his activities.

This way is common for the entire system. The Glance Cloud server gets data and triggers these data from the third-party services using their open APIs. The data and triggers are analyzed and the server decides when and what kind of information should be displayed on the clock face. The moment of display can be determined by a custom schedule or by following custom scenarios/scripts that are based on external events/triggers. A User's custom scenario can be based not on one parameter but on several triggers and parameters from different third-party services. Here are several examples.

2. Displaying Information from Smart Home Devices

The glance clock shows indoor temperature when it exceeds a certain level. The clock shows resource (electricity, water, gas) consumption at the moment the user has overused or underused the resource compared to its daily/weekly/monthly average.

3. Displaying Information from Web Services

The glance Clock shows the day schedule via integration with a digital calendar such as Google Calendar, Outlook, or the like. The calendar sends to the clock a trigger, e.g., 10 min before the event. As a result, the Glance Server requests data from the calendar and displays these data at the clock face.

4. Displaying Information from a Human-Centric System (Web Services and Smart Home Devices)

The glance clock shows a weather forecast for today at the moment the system recognizes a motion of a moving body in the room or the hall where the clock is located. Here, a smart home system sends a trigger to the Glance Cloud server to request weather forecast data from a web-service and then displays it on the clock.

The Cloud has integration with wearable electronics servers, connected device servers, and web services using their open APIs. The Cloud architecture has a modular structure and can easily increase the number of available integrations.

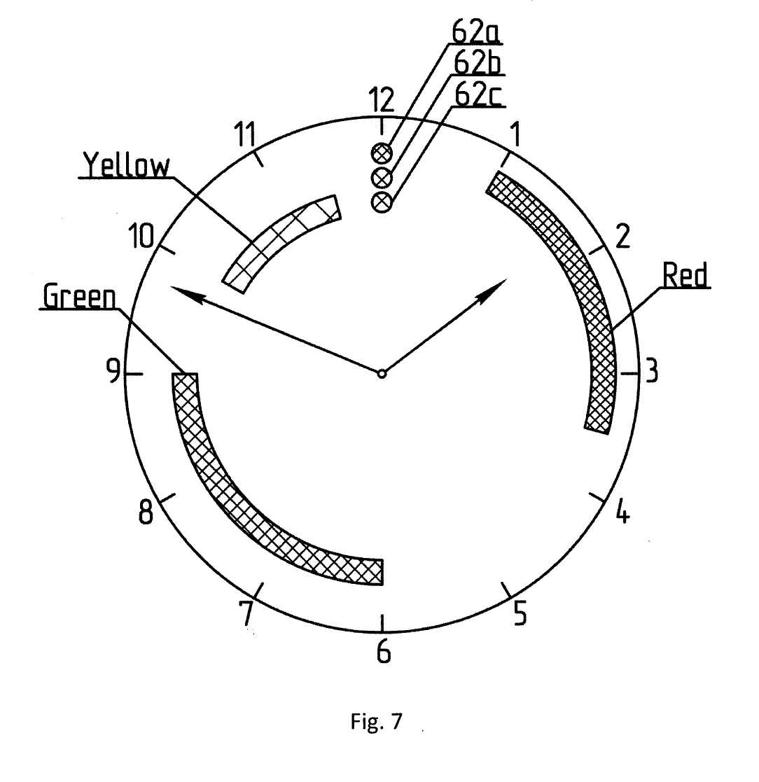

According to another aspect of the invention, the wall clock 20 has features that allow use of this wall clock as a means of visual intercommunication for members of a group of people located in different places. FIG. 7 is a simplified front view of the wall clock 20 of the invention with light indicators 62a, 62b, and 62c for use of the wall clock of the invention by a group of people, three in the illustrated case. Let us consider, for example, that these are three family members, i.e., Family Member 1, whose responsibility in the group is associated with operation of the indicator 62a; Family Member 2, whose responsibility in the group is associated with operation of the indicator 62b; and Family Member 3, whose responsibility in the group is associated with operation of the indicator 62c. All of these Family Members are located in different places and they intercommunicate with each other regarding transportation of children from school. The light indicators are arranged in different concentric circles of the LED arrays described above. Each Family Member has the clock of the invention located in an area visible at the place of his/her location, and a selected light indicator is designated for each Family Member. If necessary, the indicators may be coded by color. The indicators may comprise miniature lamps or just a virtual image of a colored circle, square, or the like. All light indicators are controlled through the Internet as other clock components operating through the Internet or microprocessor.

For example, when Family Members 1 and 2 are busy and cannot pick up the children from the school, Family Member 3 will know that in this situation the duty of picking up the children from school is his/her responsibility. Such an intercommunication task may occur, e.g., when it is not allowed or impossible to use phone communication, for example, at work.

Although the invention has been shown and described with reference to specific embodiments, it is understood that these embodiments should not be construed as limiting the areas of application of the invention and that any changes and modifications are possible, provided that these changes and modifications do not depart from the scope of the attached patent claims. For example, the system shown in FIG. 5 may incorporate a great variety of third-party components other than those shown in FIG. 5. The same relates to the structure of the Cloud shown in FIG. 6. The LED arrays may be arranged differently from those shown in the drawings. The clock of the invention may be attached not necessarily to a wall but to any surface conveniently visible to the user or users. The display components may be connected to the Internet directly, or the clock may contain a programmable microprocessor for autonomous operations. Features of the clock for group application was given only as an example, and the group may consist of office employees, manufacturing groups, etc. The LEDs may be of any type, e.g., organic light-emitting diodes (OLEDs), or the like.

1. A wall clock, comprising:
an enclosure attachable to a surface;
a clock mechanism contained in the enclosure with clock hands for indicating hours and minutes;
a plurality of LED arrays contained in the enclosure above the clock mechanism;
a translucent cover for the enclosure located above the plurality of LED arrays that covers the enclosure and comprises a clock face for designation of hours and minutes and for reproducing images of projections of light emitted by the LEDs; and
Internet communication means for controlling operation of internet-controlled components of the wall clock which are connected to predetermined devices that can operate in the Internet of Things, wherein the plurality of LED arrays is arranged in the form of a plurality of concentric circles and wherein at least a part of each circle, when lit by the LEDs of the array, designates on the clock face a time interval that corresponds to the time during which a predetermined device operates in the Internet of Things.

2. The wall clock corresponding to claim 1, wherein said at least part of each circle, when lit by the LEDs, is color coded in accordance with a predetermined device operating in the Internet of Things.

3. The wall clock according to claim 2, further provided with a color-mixing chamber that is covered with a translucent cover and comprises a plurality of cells arranged in the form of a plurality of concentric circles, wherein each array of cells is aligned with an LED array, and wherein the cells of said plurality of LED arrays are aligned with the LEDs of the LED array.

4. The wall clock according to claim 3, wherein each cell of the color-mixing chamber houses a respective LED and has a shape that uniformly distributes the light emitted by the LED.

5. The wall clock according to claim 4, further provided with a color-mixing chamber that is covered with the translucent cover and comprises a plurality of cells arranged in the form of a plurality of concentric circles, wherein each array of cells is aligned with an LED array, and wherein the cells of said plurality of LED arrays are aligned with the LEDs of the LED array.

6. The wall clock according to claim 5, wherein each cell has a shape expanded toward the translucent cover.

7. The wall clock according to claim 1, further comprising at least one linear array for textual information.

8. The wall clock according to claim 7, further provided with a color-mixing chamber that is covered with the translucent cover and comprises a plurality of cells arranged in the form of a plurality of concentric circles, wherein each array of cells is aligned with an LED array, and wherein the cells of said plurality of LED arrays are aligned with the LEDs of the LED array.

9. The wall clock according to claim 8, wherein each cell has a shape expanded toward the translucent cover.

10. The wall clock according to claim 3, further comprising at least one linear array for textual information.

11. The wall clock according to claim 1, in which the Internet-controlled components are included into a Cloud that contains at least a machine-learning engine third-party integration service, an event server, and data processors.

12. The wall clock according to claim 11, further provided with a color-mixing chamber that is covered with the translucent cover and comprises a plurality of cells arranged in the form of a plurality of concentric circles, wherein each array of cells is aligned with an LED array, and wherein the cells of said plurality of LED arrays are aligned with the LEDs of the LED array.

13. The wall clock according to claim 12, wherein each cell has a shape expanded toward the translucent cover.

14. The wall clock according to claim 2, in which the Internet-controlled components are included in a Cloud that contains at least a machine-learning engine third-party integration service, an event server, and data processors.

15. The wall clock according to claim 14, further provided with a color-mixing chamber that is covered with the translucent cover and comprises a plurality of cells arranged in the form of a plurality of concentric circles, wherein each array of cells is aligned with an LED array, and wherein the cells of said plurality of LED arrays are aligned with the LEDs of the LED array.

16. The wall clock according to claim 15, wherein each cell has a shape expanded toward the translucent cover.

17. The wall clock according to claim 3, wherein LED arrays are preassembled as a single LED matrix on a printed circuit board that contains components of electrical control and wiring, a single LED matrix having a cross-sectional shape corresponding to the shape of the color-mixing chamber so that when the color-mixing chamber is placed over the single LED matrix of LEDs, the LEDs protrude into the respective cells, which expand toward the translucent cover.

18. The wall clock according to claim 5, wherein the LED arrays are preassembled as a single LED matrix on a printed circuit board that contains components of electrical control and wiring, the single LED matrix having a cross-sectional shape corresponding to the shape of the color-mixing chamber so that when the color-mixing chamber is placed over the single LED matrix of LEDs, the LEDs protrude into the respective cells, which expand toward the translucent cover.

19. The wall clock according to claim 6, wherein LED arrays are preassembled as a single LED matrix on a printed circuit board that contains components of electrical control and wiring, the single LED matrix having a cross-sectional shape corresponding to the shape of the color-mixing chamber so that when the color-mixing chamber is placed over the single LED matrix of LEDs, the LEDs protrude into the respective cells, which expand toward the translucent cover.
